(19) United States
(12) Patent Application Publication
(10) Pub. No.: US 2011/0016310 A1
(43) Pub. Date: Jan. 20, 2011

(54) SECURE SERIAL INTERFACE WITH TRUSTED PLATFORM MODULE

(75) Inventor: Tuck Cheong YONG, Singapore (SG)

Correspondence Address: DICKSTEIN SHAPIRO LLP, 1633 Broadway, NEW YORK, NY, 10019, US

(73) Assignee: INFINEON TECHNOLOGIES AG, Neubiberg (DE)

(21) Appl. No.: 12/505,752

(22) Filed: Jul. 20, 2009

(51) Int. Cl. H04L 29/06

(52) U.S. Cl. 713/155

(57) ABSTRACT

A secure system having a Trusted Platform Module coupled between a peripheral device and a host. In operation, the Trusted Platform Module is provided to control communication between the peripheral device and the host.

### BACKGROUND

A Trusted Platform Module (“TPM”) is a microcontroller that stores keys, passwords and digital certificates. While the TPM is typically affixed to the motherboard of a personal computer (“PC”), it can be used in any computing platform that requires security functions. The Trusted Computing Group (“TCG”) developed version 1.2, which defines the concept of non-volatile storage and general purpose input output (“GPIO”) for the TPM. Moreover, an authorization mechanism for non-volatile storage defines a rich set of controls on the uses of accessing non-volatile memory and GPIO.

In general, the TPM provides core security services to the rest of the computing platform. Moreover, these security processes, such as digital signature and key exchange, are protected through the TCG subsystem. During operation of the TPM, access will be denied in the computing platform if the boot sequence is not expected. Accordingly, critical applications and capabilities including secure email, secure web access and local data protection, are effectively made much more secure than using software security features.

In addition to the foregoing features, the TPM includes capabilities such as remote attestation and sealed storage. Remote attestation creates a nearly unforgeable hash key summary of the hardware and software configuration. The summary of the software is decided by the program encrypting the data, which allows third party verification that the software has not been changed. Sealing encrypts data in such a way that it may be decrypted only if the TPM releases the associated decryption key. One specific feature of the TPM is that it can be used to authenticate hardware devices, and in particular, it can verify that a platform seeking access is the expected system. Conventional uses of the TPM, however, have not included employing the TPM to control such hardware devices.

### BRIEF DESCRIPTION OF THE DRAWINGS

FIG. 1A illustrates a block diagram of a secure system comprising Serial Peripheral Interface devices in accordance with an exemplary embodiment.

FIG. 1B illustrates a block diagram of a secure system comprising Inter-Integrated Circuit devices in accordance with an exemplary embodiment.

FIG. 1C illustrates a block diagram of a secure system comprising Single Wire Interface devices in accordance with an exemplary embodiment.

FIG. 1D illustrates a block diagram of a secure system comprising a Universal Asynchronous Receiver/Transmitter device in accordance with an exemplary embodiment.

FIG. 1E illustrates a block diagram of a secure system comprising a 1-Wire device in accordance with an exemplary embodiment.

FIG. 1F illustrates a block diagram of a secure system comprising and ISO 7816 devices in accordance with an exemplary embodiment.

FIG. 2 illustrates a table comprising configuration data for a TPM in accordance with an exemplary embodiment.

FIG. 3 illustrates a table comprising a list of Non-Volatile Indexes for a TPM in accordance with an exemplary embodiment.

FIG. 4 illustrates a table comprising configuration data for a TPM in accordance with an exemplary embodiment.

FIGS. 5A and 5B illustrate a flowchart for a method for secure communication in accordance with an exemplary embodiment.

### DETAILED DESCRIPTION

The present application is directed to a system and method of secure and trustworthy computing utilizing a TPM. More specifically, the application is directed to system and method providing a TPM configured to utilize serial communication protocols for serial peripheral devices and enable related serial communication between a host and the peripheral device.

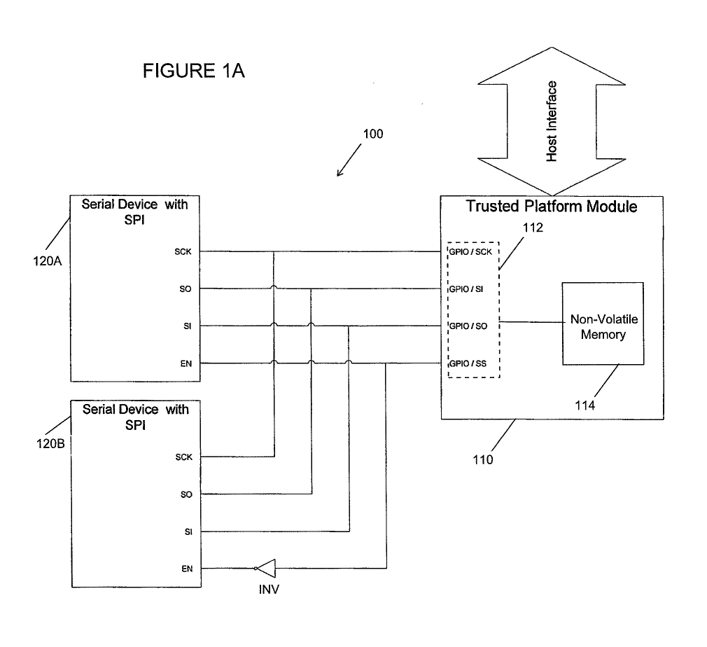

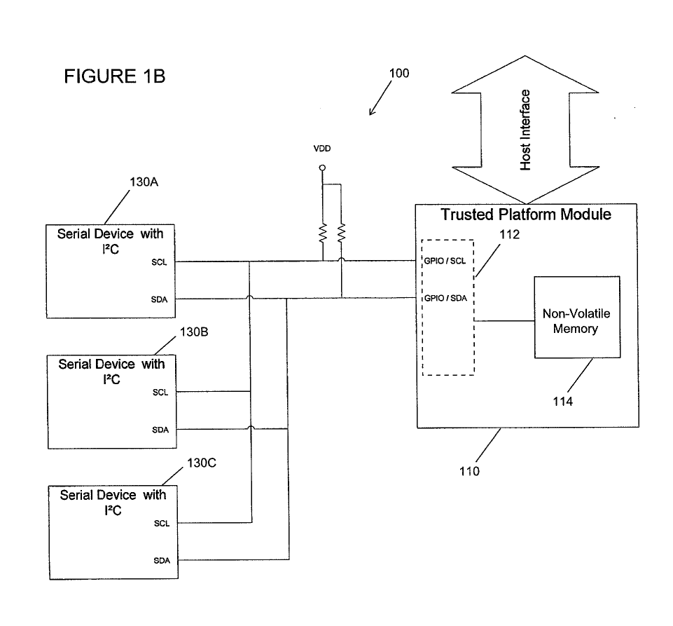

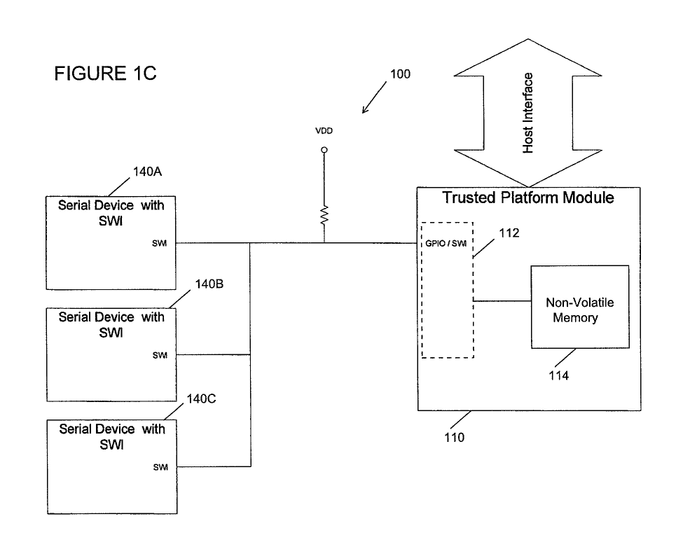

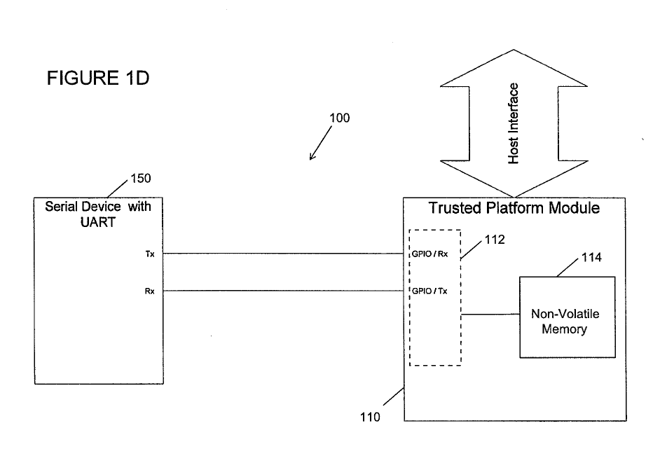

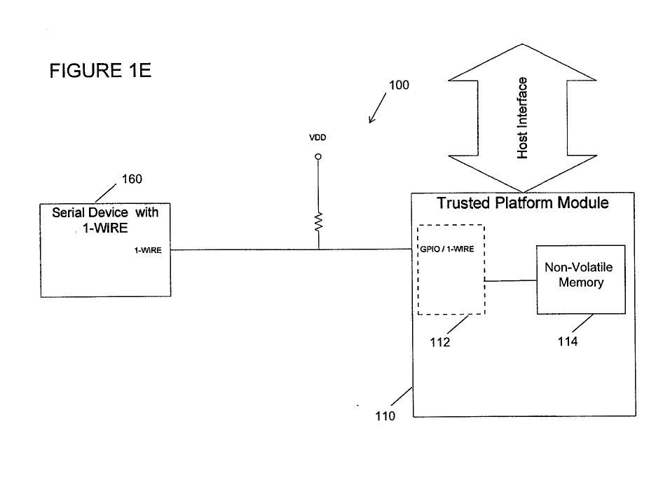

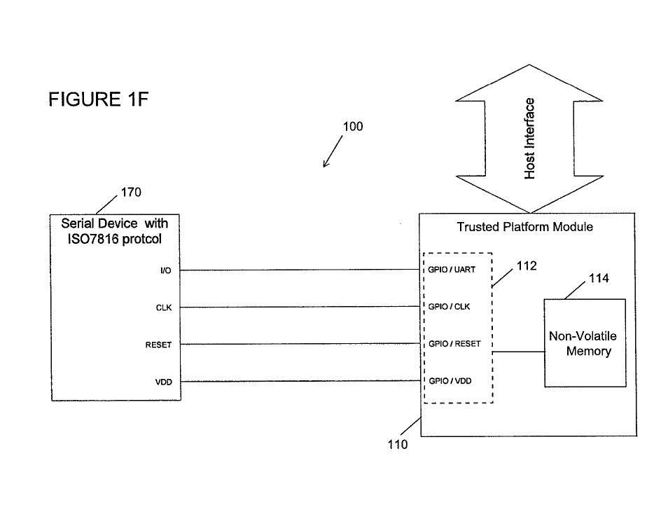

FIG. 1A illustrates a block diagram of secure system 100 in accordance with an exemplary embodiment. As shown, secure system 100 comprises TPM 110 and serial peripheral interface (“SPI”) devices 120A and 120B. TPM 110 is provided as the master device and is serially coupled to SPI devices 120A and 120B, which are the slave devices in this configuration. TPM 110 comprises GPIO interface 112 which is configured such that data can be transmitted between TPM 110 and SPI devices 120A and 120B. As a result, TPM 110 is able to control SPI devices 120A and 120B to manage communication with a host. It should further be understood that while two SPI devices are shown in this exemplary embodiment, the application is in no way intended to be limited in this manner. In alternative embodiments, TPM 110 could be serially connected to one SPI device or three or more SPI devices.

In addition, TPM 110 is coupled to a host via a host interface such as a bus. The control of TPM 110 is done via the host, for example, by using a Basic Input/Output System (BIOS) or by the operating system via a Low Pin Count Bus (LPC). While the host is not shown so as to avoid unnecessarily obscuring aspects of the application, the host may be a motherboard of a personal computer or similar computing device. Furthermore, as will described in detail below, TPM 110 comprises non-volatile memory 114. Non-volatile memory 114 is provided to store configuration data of TPM 110 to control data communication with the peripheral device, such as SPI devices 120A and 120B.

As further shown in FIG. 1A, GPIO interface 112 includes a plurality of pins enabling serial communication with SPI device 120A and 120B. Of course, those with skill in art would understand that GPIO interface 112 is not limited to communication with SPI devices 120A and 120B as illustrated in FIG. 1A. Rather, conventional TPMs generally employ GPIOs with 8 pins. Therefore, GPIO interface 112 is configurable such that TPM 110 can control serial communication with multiple types of peripheral devices. Some of the other possible peripheral devices will be discussed with respect to FIGS. 1B through 1F.

Referring back to FIG. 1A, GPIO interface 112 is provided to enable communication with SPI devices 120A and 120B. Specifically, GPIO 112 includes pins coupled to SPI signal pins, namely serial SCK, serial data input SI, serial data output SO and slave select SS. As should be known to those of ordinary skill in the art, these four pins are conventional connections for an SPI device. As further shown, an inverter INV may be coupled between SPI device 120B and GPIO interface 112 on the SS connection. Accordingly, TPM 110 can select communication between SPI device 120A and SPI device 120B when the signal of slave select SS is in a high state or a low state, respectively. The process in which TPM 110 controls communication with peripheral devices will be discussed below.

FIGS. 1B through 1F illustrate alternative embodiments of secure system 100 in accordance with the application. As noted above, GPIO interface 112 of TPM 110 is configurable such that TPM 110 can control communication with different types of peripheral devices. Moreover, non-volatile memory 114 is provided to store configuration data for TPM 110. Accordingly, FIGS. 1B through 1F illustrate different exemplary embodiments in which TPM 110 controls secure serial communication between different peripheral devices and a host.

In FIG. 1B, TPM 110, as the master device, is coupled to a plurality of Inter-Integrated Circuit (I²C) devices 130A, 130B, 130C, as the slave devices. As shown, GPIO interface 112 is configured to serially communicate with I²C devices 130A, 130B, 130C. Specifically, GPIO 112 pins are coupled to I²C signal pins, namely serial clock (SCL) and the serial data (SDA). As should be known to those of ordinary skill in the art, these two pins are conventional connections for an I²C device. In particular, both input pins are configured into an N-Channel open drain as required by conventional I²C serial interface. Moreover, multiple I²C devices can be connected to TPM 110 in this configuration provided that the mechanism to handle the I²C slave address in order to communicate with I²C devices 130A, 130B, 130C is in place.

FIG. 1C illustrates another exemplary embodiment in which TPM 110 is coupled to single wire interface (SWI) devices 140A, 140B, 140C. In this embodiment, GPIO interface 112 is configured to serially communicate with SWI devices 140A, 140B, 140C. Specifically, the pins of GPIO interface 112 are coupled to the pins of the respective SWI devices via SWI communication lines. Again, multiple SWI devices can be connected to TPM 110 in this configuration provided that the mechanism to handle the SWI slave address is in place.

FIG. 1D illustrates another exemplary embodiment in which TPM 110 is coupled to Universal Asynchronous Receiver/Transmitter (UART) 150. In this embodiment, GPIO interface 112 is configured to serially communicate with UART 150. Specifically, the pins of GPIO interface 112 interface are coupled to UART signal pins, enabling the transmission of UART Transmit Data (TxD) signal and the UART Receive Data (RxD) signal. As should be known to those of ordinary skill in the art, these two data signals are conventional communication signals for a UART device.

FIG. 1E illustrates yet another exemplary embodiment in which TPM 110 is coupled to one wire device 160. In this embodiment, the GPIO interface 112 is configured to serially communicate with one wire device 160. As shown, the 1-wire pins of each device are coupled to one another to enable data communication via the one wire signal.

Finally, FIG. 1F illustrates even another exemplary embodiment in which TPM 110 is coupled to an ISO/IEC-7816-3 device 170. ISO/IEC 7816-3 is a standard that specifies the power and signal structures, and information exchange between an integrated circuit card and an interface device such as a terminal. The standard covers signal rates, voltage levels, current values, parity convention, operating procedure, transmission mechanisms and communication with the card. As shown, the supported ISO/IEC-7816-3 devices 170 is coupled to TPM 110 via GPIO interface 112. In this embodiment, the pins of GPIO interface 112 are coupled to the respective pins of ISO/IEC-7816-3 devices 170, which include clock signal CLK, Input/Output UART for serial data to the integrated circuit inside the device 170, reset signal RESET supplied from TPM 110 and the voltage signal supplied TPM 110. As a result, TPM 110 is adapted to serially communicate with ISO/IEC-7816-3 devices 170.

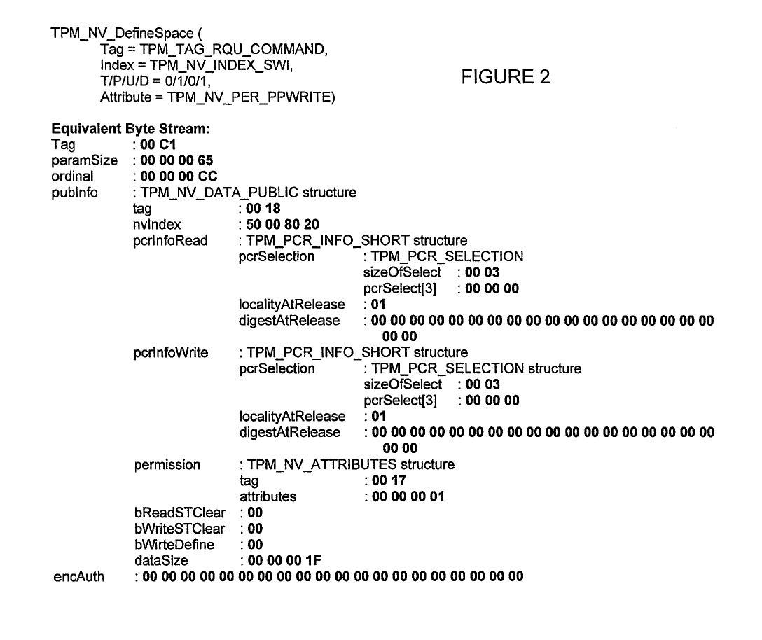

As described above and illustrated in each of FIGS. 1A-1F, TPM 110 comprises non-volatile memory 114, which can be used to store configuration data of TPM 110. Specifically, during the manufacturing process of TPM 110, communication and authentication protocol data is loaded in non-volatile memory 114. Once this data is loaded, TPM 110 is capable of controlling secure communication between the host and the specific peripheral device, which is coupled to TPM 110. FIGS. 2-4 illustrate examples of configuration data that may be loaded in non-volatile memory 114.

In particular, FIG. 2 illustrates authorization requirements and serial interface parameters that may be loaded into TPM 110 in accordance with an exemplary embodiment. Hereinafter, the exemplary configuration data shown in FIG. 2 will be referred to as “TPM_NV_DefineSpace”. While those with skill in the art of TPMs would understand the implementation of the byte stream parameters illustrated in TPM_NV_DefineSpace, as shown, “nvIndex” is an additional parameter which provides an identification of the particular peripheral device coupled to TPM 110. For example, the nvIndex illustrated in FIG. 2 is “50 00 80 20”, which corresponds to the specific peripheral device. Accordingly, once the system engineer determines which peripheral device is to be coupled to TPM 110, the configuration data TPM_NV_DefineSpace is defined with the nvIndex corresponding to that peripheral device

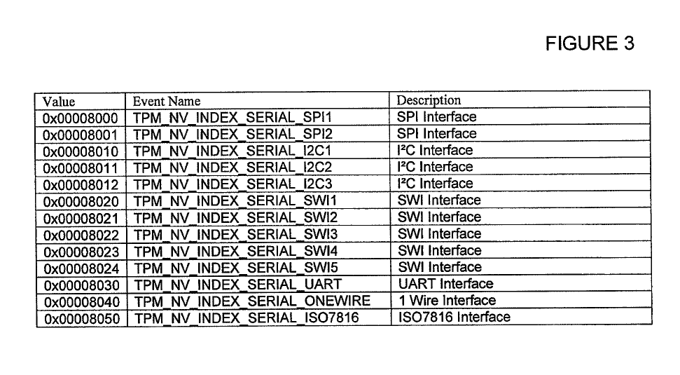

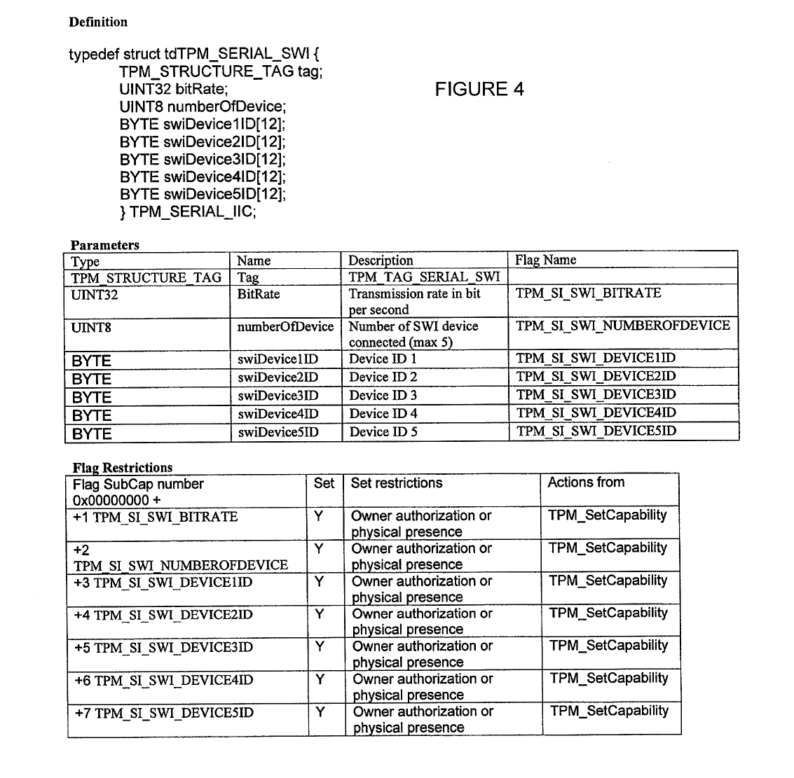

FIG. 3 illustrates an exemplary list of non-volatile (“NV”) indexes for the possible interfaces of the different serial devices. The list of NV indexes are also provided to TPM 110 during the manufacturing process and enables TPM 110 to read the stored TPM_NV_DefineSpace and identify the corresponding peripheral device. The index value “50 00 80 20” as shown in FIG. 3 corresponds to the SWI device on the first of five channels. Thus, in this example, the nvIndex “0x00008020” is indicating that TPM 110 is coupled to the first SWI device of the five channels, for example, SWI device 140A of FIG. 1C (except that FIG. 1C is shown to have only three channels). It is reiterated that the three SWI devices shown in FIG. 1C are merely provided as an example. Moreover, the list of NV indexes in FIG. 4 is a separate example, which lists five SWI devices. Accordingly, it should also be clear that the index values listed in FIG. 3 are merely shown as examples and that the application is in no way intended to be limited by these values.

Referring back to FIG. 2, nvIndex value “50 00 80 20” (corresponding to “0x00008020” in FIG. 3) indicates that TPM 110 is being loaded with authorization requirements, i.e., the ordinal byte stream to define the security attributes of the SWI device. In addition, the values of TPM_NV_DefineSpace provide the serial interface parameters to enable communication with SWI device 140A. For example, the maximum data length of the serial interface could be defined under the field name dataSize with the exemplary value “00 00 00 1F”. Moreover, other security settings could be defined by similar methods. These exemplary parameters are shown to demonstrate that TPM_NV_DefineSpace of FIG. 2 is provided to configure the authentication and communication protocols between TPM 110 and the respective peripheral device.

FIG. 4 illustrates further configuration data that is provided to TPM 110 during the manufacturing process and will be referred to as “TPM_SetCapability”. The TPM_SetCapability is a list configuration parameters used during operation to define the transmission rate with the particular peripheral device coupled to TPM 110. For instance, each type of peripheral device, e.g., an SPI device or SWI device, may have a different transmission rate or bit rate. As shown in FIG. 4, the TPM_SetCapability is an example of the configuration parameters for the SWI devices discussed above in the application and illustrated in FIG. 1C.

Specifically, the TPM_SetCapability illustrates that the bit rate of the SWI device could be configured under the bitRate field with type unsigned integer (UINT32). Moreover, to communicate between multiple SWI devices (as shown in FIG. 1C), different index values nvIndex can be used as illustrated in FIG. 3. The slave addresses of the SWI devices can be stored in the device ID fields. Additionally, when the numberOfDevice field is set to zero, the host could issue a search ID command in order to detect which available devices are connected to GPIO interface 112. For example, in FIG. 1C, SWI devices 140A, 140B and 140C are available for communication. Once the host has determined the number of devices connected, the host can then store the ID and the number of SWI devices in the TPM_SERIAL_SWI structure via the TPM_SetCapability configuration data.

In addition to the table of parameters, TPM_SetCapability configuration data further includes a table of Flag Restrictions. As should be clear, the parameters set forth in the column Flag SubCap number correspond to the parameters shown above in the Parameter table. The Flag Restrictions table indicates that restrictions such as “owner authorization” or “physical presence” can be set for each parameter. As a result, the system designer can control the authorization of the peripheral devices.

It is reiterated that FIG. 4 is an exemplary set of configuration parameters to enable communication between the SWI devices and the TPM 110 as shown in FIG. 1C. Accordingly, the configuration parameters TPM_SetCapability are merely shown as an example and the application is in no way intended to be limited by these values. Moreover, the application contemplates that similar configuration parameters for each of the other peripheral devices described above may be provided to TPM 110 for the instances when TPM 110 is coupled to those respective peripheral devices.

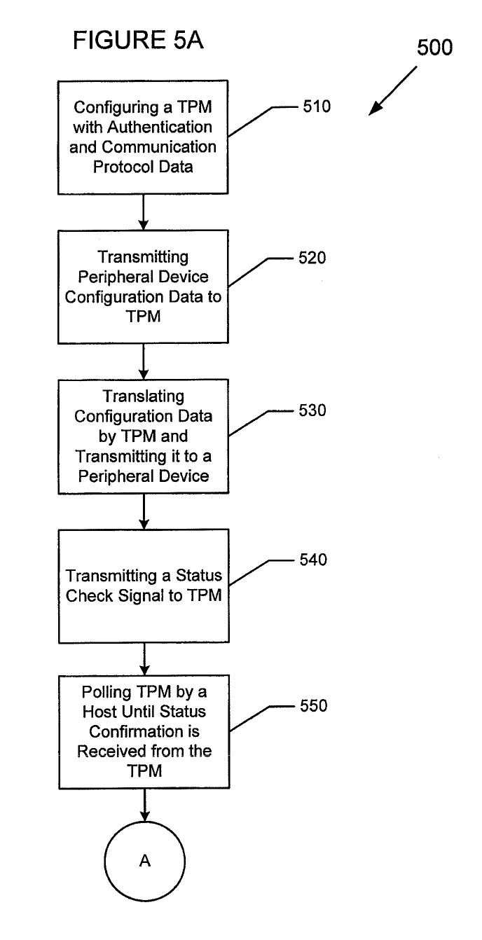

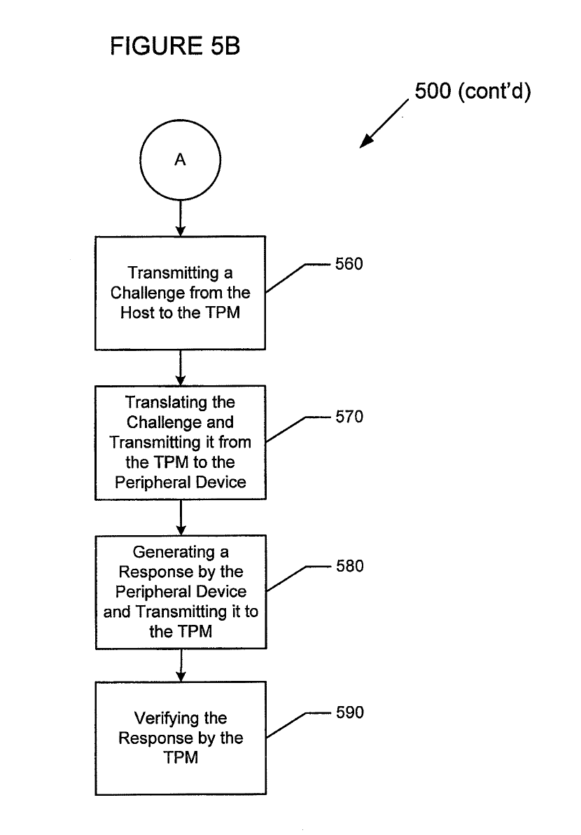

FIG. 5A illustrates a flowchart 500 of a method for secure communication in accordance with an exemplary embodiment. In this method of secure communication, the TPM described is the exemplary TPM 110 discussed above with respect to any of FIGS. 1A through 1F. As shown in Step 510, TPM 110 is initially configured with authentication and communication protocol data, respectively. As discussed above, these steps are performed during the manufacturing process of TPM 110 and can be defined by the design engineer. Moreover, this authentication and communication protocol data is stored in nonvolatile memory 114 of TPM 110. The protocol data will include TPM_NV_DefineSpace, TPM_SetCapability and the list of NV indexes.

Once manufacturing is complete and TPM 110 is coupled to a host as described above, TPM 110 is ready to control the connected hardware device and provide secure communication with the host. In order to initiate communication upon system power up, the host transmits configuration data using a TPM_NV_WRITE command to TPM 110 (Step 520). This TPM_NV_WRITE command is provided to configure the actual peripheral device. At Step 530, TPM 110 translates configuration command TPM_NV_WRITE to the targeted serial protocol frame and transmits it to the serial device connected to TPM 110. In particular, TPM 110 utilizes the configuration data stored in non-volatile memory 114 to translate the TPM_NV_WRITE command. The serial device can be any of those hardware devices described above with respect to FIGS. 1A through 1F.

Next, at Step 540, the host transmits a status check signal to TPM 110, which relays this request to the connected peripheral device. TPM 110 waits to receive a confirmation signal from the serial device that it is correctly configured. The host subsequently polls TPM 110 until it receives status confirmation from TPM 110 (Step 550). Once TPM 110 receives status confirmation from the serial device and relays the status to the host, the host can begin secure serial communication with the serial device via TPM 110. Effectively, TPM 110 is able to control the particular peripheral device such that data can be sent to and from the host.

In a further aspect of this method, the secure system can perform a challenge-response authentication. Challenge-response authentication is a family of protocols in which one party presents a question (“challenge”) and another party provides an answer (“response”) to be authenticated. In some implementations of this technique, an encryption key is used to encrypt a randomly-generated number as the challenge, and, in response, the hardware device will return a similarly-encrypted value which can be some predetermined function of the originally-offered information. As a result, the hardware device has effectively proved that it was able to decrypt the challenge.

FIG. 5B illustrates a flowchart for this additional aspect of the method. As shown, FIG. 5B is a continuation of the method shown in FIG. 5A. Specifically, after the status of the peripheral device's configuration has been confirmed to the host, the host then transmits a challenge via the TPM_NV_WRITE command to TPM 110 (Step 560). Next, at Step 570, TPM 110 translates the challenge command to the targeted serial protocol frame and sends it to the peripheral device coupled to TPM 110. At Step 580, the peripheral device provides a response to TPM 110, which verifies the response data (Step 590). These challenge results are then transmitted back to the host, and once confirmed, the secure communication between the two entities can commence.

While the foregoing has been described in conjunction with an exemplary embodiment, it is understood that the term “exemplary” is merely meant as an example, rather than the best or optimal. Accordingly, the application is intended to cover alternatives, modifications and equivalents, which may be included within the spirit and scope of the invention.

Additionally, in the preceding detailed description, numerous specific details have been set forth in order to provide a thorough understanding of the present invention. However, it should be apparent to one of ordinary skill in the art that the inventive test circuit may be practiced without these specific details. In other instances, well-known methods, procedures, components, and circuits have not been described in detail so as not to unnecessarily obscure aspects of the application.

What is claimed is:

1. A secure system, comprising:
a peripheral device; and
a Trusted Platform Module (TPM) coupled between the peripheral device and a host, and configured to control communication between the peripheral device and the host.

2. The secure system of claim 1, wherein the TPM and peripheral device are coupled via a serial interface.

3. The secure system of claim 1, wherein the TPM comprises non-volatile memory configured to store configuration data, which defines authentication and data transmission protocols to control the communication between the peripheral device and the host.

4. The secure system of claim 1, wherein the configuration data is loaded in the non-volatile memory during manufacture of the TPM.

5. The secure system of claim 1, wherein the peripheral device is a serial peripheral interface device.

6. The secure system of claim 1, wherein the peripheral device is a inter-integrated circuit device.

7. The secure system of claim 1, wherein the peripheral device is a single wire interface device.

8. The secure system of claim 1, wherein the peripheral device is a universal asynchronous receiver/transmitter device.

9. The secure system of claim 1, wherein the peripheral device is a one-wire device.

10. The secure system of claim 1, wherein the peripheral device is a ISO 7816-compliant device.

11. A secure computing method, comprising:
providing a peripheral device; and
providing a trusted platform module (TPM) coupled between the peripheral device and a host; and
controlling communication, by the TPM, between the peripheral device and the host.

12. The secure computing method of claim 11, wherein the controlling communication comprises controlling communication between the peripheral device and the TPM in a serial manner.

13. The secure computing method of claim 11, wherein the controlling communication comprises transmitting configuration data from the host to the peripheral device via the TPM.

14. The secure computing method of claim 11, wherein the controlling communication comprises transmitting status data from the peripheral device to the host via the TPM.

15. The secure computing method of claim 11, wherein the controlling communication comprises transmitting challenge data from the host to the peripheral device via the TPM.

16. The secure computing method of claim 15, wherein the controlling communication comprises transmitting a response to the challenge data from the peripheral device to the TPM.

17. The secure computing method of claim 16, wherein the controlling communication comprises verifying the response by the TPM.

18. The secure computing method of claim 16, wherein the controlling communication comprises transmitting the verified response to the host.

19. The secure computing method of claim 15, wherein the challenge data is a randomly generated number.

20. A Trusted Platform Module comprising:
a general purpose input output (GPIO) adapted to be coupled to a peripheral device; and
a non-volatile memory configured to store configuration data, which defines authentication and data transmission protocols to control communication between a host and the peripheral device.

21. The Trusted Platform Module of claim 20, wherein the configuration data is loaded in the non-volatile memory during manufacture of the Trusted Platform Module.

22. The Trusted Platform Module of claim 20, wherein the Trusted Platform Module is configured to communicate data with the peripheral device, via the GPIO, and wherein the data transmission is controlled by the authentication and data transmission protocols.

23. A secure system, comprising:
a peripheral means for performing a computing operation;
a trusted platform module (TPM) coupled between the peripheral device and a host, for controlling communication between the peripheral device and the host;
an interface means for coupling the peripheral means and the TPM.

24. The secure system of claim 23, further comprising a non-volatile memory means for storing configuration data, which defines authentication and data transmission protocols for controlling the communication between the peripheral device and the host.
